(19) United States
(12) Patent Application Publication
(10) Pub. No.: US 2015/0329039 A1
(43) Pub. Date: Nov. 19, 2015

(54) BLINKER-ACTIVATED WARNING SYSTEM FOR VEHICLES

(71) Applicant: Gardex Ltee, Mont-Laurier (CA)

(72) Inventor: Jacques Courcelles, Mont-Laurier (CA)

(73) Assignee: Gardex Ltee, Mont-Laurier (CA)

(21) Appl. No.: 14/593,605

(22) Filed: Jan. 9, 2015

Related U.S. Application Data
(60) Provisional application No. 62/044,680, filed on Sep. 2, 2014.
(60) Provisional application No. 61/994,404, filed on May 16, 2014.

(51) Int. Cl. B60Q 1/34; B60Q 1/44

(52) U.S. Cl. CPC B60Q 1/34; B60Q 1/44

(57) ABSTRACT

A warning system for a vehicle includes an alarm sound generating unit connectable to a control circuit controlling side blinkers signals for the vehicle and which generates an alarm sound upon actuation by an operator of the vehicle. The alarm sound generating unit is also connectable to a brake signal control circuit controlling brake signals. Hence, the operator does not have to actively actuate the warning system as it is automatically activated upon actuating the blinkers. Therefore, no extra action with respect to the usual driving of the vehicle is required from the operator in order to activate this additional safety system, as the system simply gets activated through the use of the vehicle blinker system. In order to minimize and avoid alarm sounds when the vehicle is not moving, the alarm sound is muted through the brake signal control circuit upon receipt of a signal indicative of an absence of movement of the vehicle.

### FIELD OF THE INVENTION

The present invention generally relates to warning systems, and is more particularly directed to a warning system for a vehicle.

### BACKGROUND

There have been a number of recent road accidents where unsuspecting pedestrians or cyclists have been hit by large vehicles turning around a corner.

Prior art vehicles have included sound alarm systems, such as back-up alarms, to alert individuals in proximity of a moving vehicle that it is backing up.

U.S. Pat. No. 8,477,025 describes a vehicle, in particular a lorry or bus, provided with a device for issuing, in the event of the vehicle turning off, an acoustic warning signal in the direction of a warning region next to the vehicle. In order to reduce noise pollution, a sound director device is required for sending the acoustic warning signal in a preferred direction. Unfortunately, the acoustic warning signal can be generated even if the vehicle is immobilized or requires significant manual control to temporarily deactivate the device issuing the acoustic warning signal in order to reduce ambient noise pollution.

Accordingly, there is a need for a warning system that addresses at least one of the above-mentioned problems.

### SUMMARY

An object of the invention is to provide a warning system that addresses at least one of the above-mentioned needs.

According to the present invention, there is provided a warning system for a vehicle comprising:
an alarm sound generating unit connectable to a blinker control circuit controlling side blinkers signals for the vehicle and connectable to a brake signal control circuit controlling brake signals for the vehicle,
   wherein the alarm sound generating unit generates an alarm sound upon actuation by an operator of the vehicle blinker signals and wherein the alarm sound is muted through the brake signal control circuit upon receipt of a signal indicative of an absence of movement of the vehicle.

In an embodiment, the signal indicative of the absence of movement of the vehicle is generated by the brake control circuit.

In an embodiment, the signal indicative of the absence of movement of the vehicle is generated by a movement detecting system circuit.

In an embodiment, the signal indicative of the absence of movement of the vehicle is generated by a movement detecting camera.

In an embodiment, the signal indicative of the absence of movement of the vehicle is generated by a Global Positioning System circuit.

In an embodiment, the signal indicative of the absence of movement of the vehicle is generated by an electronic device position tracking system circuit.

In an embodiment, the signal indicative of the absence of movement of the vehicle is generated by a movement detecting system integrated with vehicle transmission/drive components.

In an embodiment, the alarm sound is synchronized with a flashing of the blinker signals. In other embodiments, the alarm system is not synchronized with the flashing.

In an embodiment, the alarm sound generating unit positioned on a side of the vehicle at a position and level appropriate for alerting an average-sized pedestrian or cyclist proximate a side of the vehicle.

According to the present invention, there is also provided a vehicle comprising a warning system as described above.

In an embodiment, the vehicle is selected from the group comprising trucks, trailer trucks, dump trucks, garbage trucks, snowplow trucks, oversized vehicles, commuter vehicles, buses, and school buses.

In an embodiment, the vehicle can include a plurality of said warning systems spaced along a length of the vehicle.

In an embodiment, the vehicle can further include a kill-switch for selectively deactivating the warning system.

In an embodiment, the vehicle can further include at least one of a proximity detection sensor and a side-vehicle camera system for detecting a presence of a pedestrian or a cyclist proximate a side of the vehicle.

In an embodiment, the vehicle can further include an alarm sound control device controlling a volume of the alarm sound as a function of ambient noise surrounding the vehicle.

Some objects, advantages and other features will become more apparent upon reading the following non-restrictive description of certain optional configurations, given for the purpose of exemplification only, with reference to the accompanying drawings.

### BRIEF DESCRIPTION OF THE DRAWINGS

Further aspects and advantages of the present invention will become better understood with reference to the description in association with the following Figures, in which similar references used in different Figures denote similar components, wherein:

FIG. 1 is a schematic view of a warning system according to an embodiment of the present invention.

### DETAILED DESCRIPTION

In the following description, the same numerical references refer to similar elements. Furthermore, for the sake of simplicity and clarity, namely so as to not unduly burden the figures with several references numbers, not all figures contain references to all the components and features, and references to some components and features may be found in only one figure, and components and features of the present disclosure which are illustrated in other figures can be easily inferred therefrom. The embodiments, geometrical configurations, materials mentioned and/or dimensions shown in the figures are optional, and are given for exemplification purposes only.

Furthermore, although the present invention may be used with a road vehicle, for example, it is understood that it may be used with other types of vehicles, for other purposes. For this reason, expressions such as “truck”, “bus”, etc. as used herein should not be taken as to limit the scope of the present invention to being used with these vehicles in particular. These expressions encompass all other kinds of materials, objects and/or purposes with other types of vehicles with which the present invention could be used and may be useful.

In addition, although the optional configurations as illustrated in the accompanying drawings comprises various components and although the optional configurations of the alarm system as shown may consist of certain geometrical configurations as explained and illustrated herein, not all of these components and geometries are essential and thus should not be taken in their restrictive sense, i.e. should not be taken as to limit the scope of the present disclosure. It is to be understood that other suitable components and cooperations thereinbetween, as well as other suitable geometrical configurations may be used for the alarm system, and corresponding parts, as briefly explained and as can be easily inferred herefrom, without departing from the scope of the disclosure.

### NUMERICAL REFERENCES USED IN THE FIGURES

10—Warning system
12—Vehicle
13—Flashers lights
14—Loud speaker/alarm/buzzer
16—Blinker control circuit
18—SPST Parked vehicle switches
20—Brake signal control circuit
22—Brake lights
24—Relay units
26—Global Positioning System (GPS)
28—Movement detecting system
30—Positioning system using cell tower signals
32—Global hybrid system for the positioning of electronic devices by WiFi, WiMAX, GSM, LTE, IP addresses and network environment
34—Movement detecting system integrated with transmission/drive components
36—Movement detecting camera

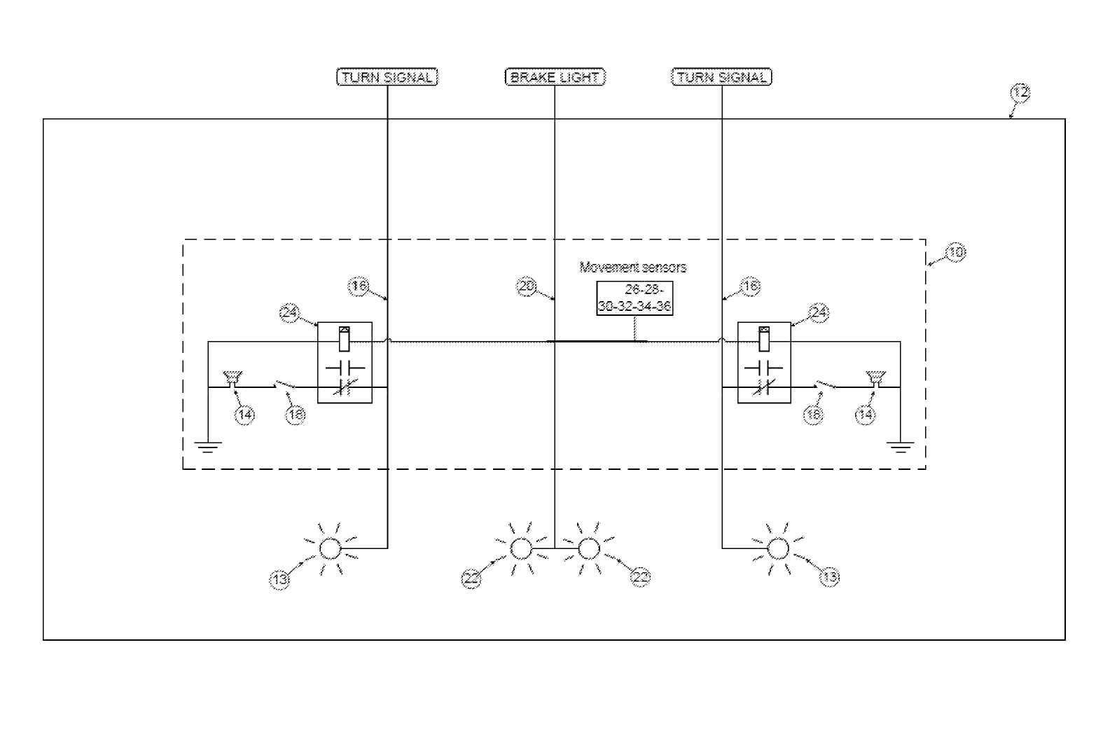

Referring to FIG. 1, a warning system 10 is shown. The warning system 10 for a vehicle 12 includes an alarm sound generating unit 14 connectable to a blinker control circuit 16 controlling side blinkers signals 13 for the vehicle 12. The alarm sound generating unit 14 is also connectable to a brake signal control circuit 20 controlling brake signals 22 for the vehicle 12. The alarm sound generating unit 14 is also connectable to a movement detecting system circuit 28 or a movement detecting camera 36 that would stop the alarm sound when the vehicle is not moving. The alarm sound generating unit 14 is also connectable to a GPS (Global Positioning System) circuit 26 that would stop the alarm sound when the vehicle is not moving. The alarm sound generating unit 14 is also connectable to an electronic device (for example a mobile phone) position tracking system circuit that would stop the alarm sound when the vehicle is not moving. The alarm sound generating unit 14 is also connectable to a movement detecting system 34 present in the anti-locking braking systems circuit, or otherwise integrated with transmission/drive components that would stop the alarm sound when the vehicle is not moving. The alarm sound generating unit 14 (for example a Grote™ Model 73040—97 Decibels alarm or a Brigade Electronics SS-BC-08—90 Decibels alarm, or any other similar alarm best suited for the operational environment where the warning system will be used) generates an alarm sound upon actuation by an operator of the vehicle blinker signals. Hence, the operator does not have to actively actuate the warning system as it is automatically activated upon actuating the left or right side blinkers for the vehicle. Therefore, no extra action with respect to the usual driving of the vehicle is required from the operator in order to activate this additional safety system, as the system simply gets activated through the use of the vehicle blinker system. However, in order to minimize and avoid the emission of an alarm sound when the vehicle is not moving or waiting at an intersection, the alarm sound is muted through the brake signal control circuit upon actuation of the brakes on the vehicle. Upon release of the brakes and upon the initiation of movement of the vehicle, the alarm sound is produced once again to warn any proximate bystander. A relay unit 24, for example a TE Connectivity™ 1432791-1 relay, coordinates the above-described interplay between the emission of the alarm sound, the blinker signals and the brake signals.

In an embodiment, the alarm sound is synchronized with a flashing of the blinker signals. The alarm sound or beep can be synchronized with the electrical source feeding the blinker system for left or right turns. In other embodiments, the alarm system is not synchronized with the flashing of the blinker signals.

In an embodiment, the alarm sound generating unit positioned on a side of the vehicle at a position and level appropriate for alerting an average-sized pedestrian or cyclist proximate a side of the vehicle. Therefore, the warning system increases the safety of any pedestrian or cyclist located in close proximity of the vehicle as the alarm alerts them of a maneuver of the vehicle, such that the pedestrian or cyclist can move out of the way to a safer location. The volume of the warning system can be adjusted or increased so that it can serve a warning to people who are hearing impaired and who may not otherwise be aware of the danger approaching them as the vehicle turns around a corner. Moreover, the warning system can also serve as an interesting safety feature for blind people, or people with any visual impairments, for which the visual blinker system does not serve of a proper warning. The alarm sound is much more of an appropriate warning for these people of the upcoming maneuver of the vehicle. The type and sequencing of the alarm sound can be adjusted in order to not create any confusion with other alarm sounds associated with vehicles (such as a backing up audible signal or the like) or with traffic in general.

According to the present invention, there is also provided a vehicle including a warning system as described above.

In an embodiment, the vehicle is selected from the group comprising trucks, trailer trucks, dump trucks, garbage trucks, snowplow trucks, oversized vehicles, commuter vehicles, buses, and school buses. Other vehicles that may be considered include touring vehicles, heavy equipment vehicles, graders, pull shovel or crane vehicles

In an embodiment, the vehicle can include a plurality of said warning systems spaced along a length of the vehicle on the side of the vehicle that is opposite the driver's side. The vehicle can thus include 1, 2, 3 warning systems for example, or more as deemed appropriate.

In an embodiment, the vehicle can further include a kill-switch, for example a 10A switch, for selectively deactivating the warning system. The operator can thus temporarily deactivate the system if necessary.

In an embodiment, the vehicle can further include at least one of a proximity detection sensor and a side-vehicle camera system for detecting a presence of a pedestrian or a cyclist proximate a side of the vehicle, opposite or not the driver's side.

In an embodiment, the vehicle can further include an alarm sound control device controlling a volume of the alarm sound as a function of ambient noise surrounding the vehicle.

As can be seen in the schematic shown in FIG. 1, the warning system can be implemented on a vehicle by using simple components and is therefore inexpensive to install or retrofit on a vehicle (or to provide as standard equipment on new vehicles). The simple circuit architecture between the warning system, the blinker signals and the brake signals is also generally less prone to system failures and easier to repair with inexpensive simple replacement parts if a failure occurs.

Of course, numerous modifications could be made to the above-described configurations without departing from the scope of the disclosure.

1. A warning system for a vehicle comprising:
an alarm sound generating unit connectable to a blinker control circuit controlling side blinkers signals for the vehicle and connectable to a brake signal control circuit controlling brake signals for the vehicle,
wherein the alarm sound generating unit generates an alarm sound upon actuation by an operator of the vehicle blinker signals and wherein the alarm sound is muted through the brake signal control circuit upon receipt of a signal indicative of an absence of movement of the vehicle.

2. The warning system according to claim 1, wherein the alarm sound is synchronized with a flashing of the blinker signals.

3. The warning system according to claim 1, wherein the alarm sound generating unit positioned on a side of the vehicle at a position and level appropriate for alerting an average-sized pedestrian or cyclist proximate a side of the vehicle.

4. The warning system according to claim 1, wherein the signal indicative of the absence of movement of the vehicle is generated by the brake control circuit.

5. The warning system according to claim 1, wherein the signal indicative of the absence of movement of the vehicle is generated by a movement detecting system circuit.

6. The warning system according to claim 1, wherein the signal indicative of the absence of movement of the vehicle is generated by a movement detecting camera.

7. The warning system according to claim 1, wherein the signal indicative of the absence of movement of the vehicle is generated by a Global Positioning System circuit.

8. The warning system according to claim 1, wherein the signal indicative of the absence of movement of the vehicle is generated by an electronic device position tracking system circuit.

9. The warning system according to claim 1, wherein the signal indicative of the absence of movement of the vehicle is generated by a movement detecting system integrated with vehicle transmission/drive components.

10. A vehicle comprising a warning system according to claim 1.

11. The vehicle according to claim 10, wherein the vehicle is selected from the group comprising trucks, trailer trucks, dump trucks, garbage trucks, snowplow trucks, oversized vehicles, commuter vehicles, buses, and school buses.

12. The vehicle according to claim 10, comprising a plurality of said warning systems spaced along a length of the vehicle.

13. The vehicle according to claim 10, further comprising a kill-switch for selectively deactivating the warning system.

14. The vehicle according to claim 10, further comprising at least one of a proximity detection sensor and a side-vehicle camera system for detecting a presence of a pedestrian or a cyclist proximate a side of the vehicle.

15. The vehicle according to claim 10, further comprising an alarm sound control device controlling a volume of the alarm sound as a function of ambient noise surrounding the vehicle.
